(19) United States
(12) Patent Application Publication
(10) Pub. No.: US 2026/0299124 A1
(43) Pub. Date: Oct. 1, 2026

(54) DETECTION MODULE AND MACHINE INCLUDING THE SAME

(71) Applicant: Advanced Semiconductor Engineering, Inc., Kaohsiung (TW)

(72) Inventor: Chun-Kai CHANG, Kaohsiung (TW)

(73) Assignee: Advanced Semiconductor Engineering, Inc., Kaohsiung (TW)

(21) Appl. No.: 19/094,785

(22) Filed: Mar. 28, 2025

(51) Int. Cl. G01S 15/86; G01S 7/481; G01S 7/521; G01S 15/93; G01S 17/93

(52) U.S. Cl. CPC G01S 15/86; G01S 7/4813; G01S 7/4814; G01S 7/4816; G01S 7/521; G01S 15/93; G01S 17/93

(57) ABSTRACT

The present disclosure provides a machine. The machine includes a main body, a first detection module connected to the main body, a second detection module connected to the main body, and an electronic component wirelessly communicating with the first detection module and the second detection module. A detection distance of the first detection module and a detection distance of the second detection module are different. The electronic component is configured to control a movement of the main body. A detection module is also provided.

### BACKGROUND

### 1. Technical Field

The present disclosure relates to a detection module, and a machine including the detection module.

### 2. Description of the Related Art

Currently, in the field of robotics, particularly with humanoid robots, optical sensors or LiDAR are commonly integrated into the head to track movement paths, determine limb actions, and avoid collisions. However, if these optical sensors experience blind spots or obstructions, the robot may struggle to respond in real-time, which can increase the risk of collisions.

### SUMMARY

In some arrangements, a machine includes a main body, a first detection module connected to the main body, a second detection module connected to the main body, and an electronic component wirelessly communicating with the first detection module and the second detection module. A detection distance of the first detection module and a detection distance of the second detection module are different. The electronic component is configured to control a movement of the main body.

In some arrangements, a detection module includes a distance detection unit and a communication unit wirelessly communicating with a processing unit. The communication unit includes an antenna in a soft material.

In some arrangements, a detection module includes a distance detection unit, a communication unit wirelessly communicating with a processing unit, and a fastening component that allows the detection module to be attached to and detached from a designated area of an external surface of a machine.

### BRIEF DESCRIPTION OF THE DRAWINGS

Aspects of some arrangements of the present disclosure are best understood from the following detailed description when read with the accompanying figures. It is noted that various structures may not be drawn to scale, and dimensions of the various structures may be arbitrarily increased or reduced for clarity of discussion.

FIG. 1 illustrates a cross-sectional view of a detection module in accordance with some arrangements of the present disclosure.

FIG. 2A illustrates a detection module before it is attached to a machine in accordance with some arrangements of the present disclosure.

FIG. 2B illustrates a detection module after it has been attached to a machine in accordance with some arrangements of the present disclosure.

FIG. 3 illustrates an enlarged view of a machine featuring a detection module in accordance with some arrangements of the present disclosure.

FIG. 4 illustrates a machine equipped with a detection module in accordance with some arrangements of the present disclosure.

FIG. 5A illustrates one or more steps in a process flow that demonstrate how a machine avoids collisions by using a detection module in accordance with some arrangements of the present disclosure.

FIG. 5B illustrates one or more steps in a process flow that demonstrate how a machine avoids collisions by using a detection module in accordance with some arrangements of the present disclosure.

### DETAILED DESCRIPTION

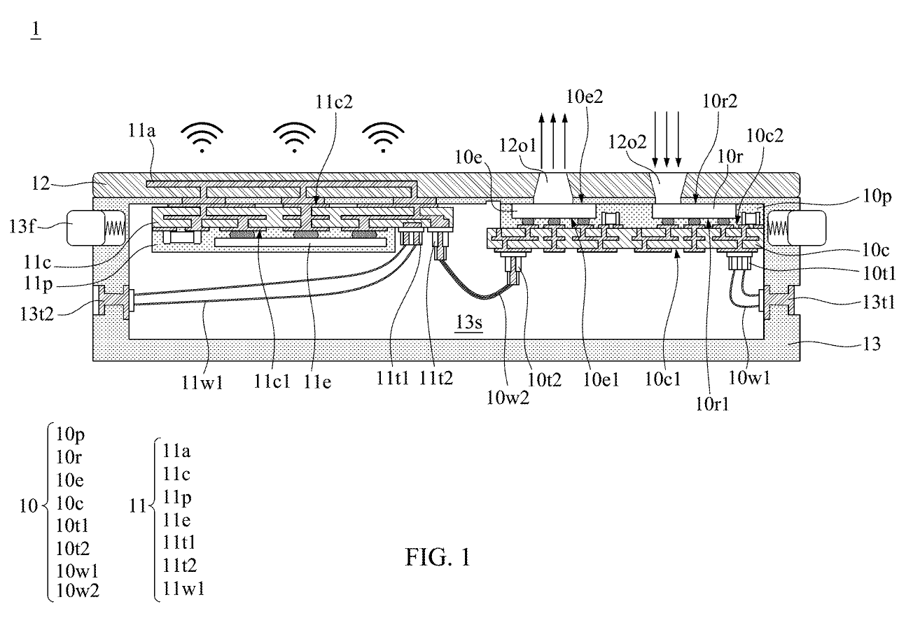

FIG. 1 illustrates a cross-sectional view of a detection module 1 in accordance with some arrangements of the present disclosure. In some arrangements, the detection module 1 may include a distance detection unit 10, a communication unit 11, a dielectric material 12, and a housing 13.

The housing 13 may include a cap, cover, lid, top, or another structure. The housing 13 may define a space 13s for accommodating the distance detection unit 10 and the communication unit 11. From a cross-sectional view, the housing 13 may have a rectangular shape with four sides. For example, the bottom side of housing 13 may be horizontally oriented and in contact with the dielectric material 12. The lateral sides of housing 13 may be vertically oriented and positioned next to the distance detection unit 10 and the communication unit 11. The top side of housing 13 may also be horizontally oriented and supported above the distance detection unit 10 and the communication unit 11 by the lateral sides of housing 13.

The housing 13 may include a fastening component 13f. The fastening component 13f may be positioned or installed over the lateral side of housing 13. The fastening component 13f may be configured to allow the detection module 1 to be attached to and detached from a designated area of a machine's external surface. In some arrangements, there may be any number of fastening components depending on design requirements.

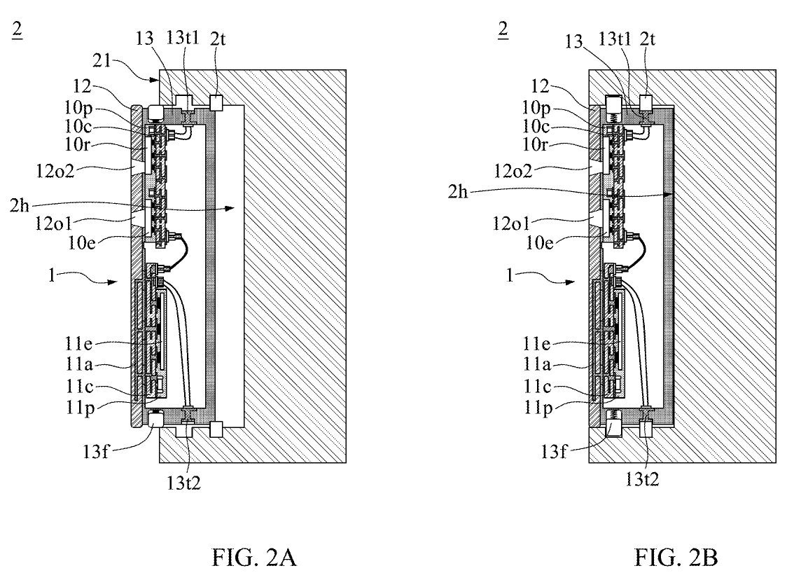

For example, FIGS. 2A and 2B illustrate the detection module 1 before and after it is attached to a machine 2. The machine 2 may include a portion of a robot (such as a humanoid robot or an industrial robot), an autonomous vehicle, a consumer electronic device (such as a smartphone or a smart home device), etc. After the detection module 1 is attached to the machine 2, it may provide one or more functions, such as distance sensing, proximity sensing, obstacle avoidance, collision avoidance, material handling, mapping, and more.

The machine 2 may have an external surface 21, which may be the outermost surface visible to the user. The external surface 21 may be constructed from various materials, such as polymer (like plastic, rubber, and fiber), metal, or glass, and could be designed with specific textures, colors, and finishes to enhance its visual appeal. The external surface 21 may house components such as circuitry or controllers that provide functionality for the machine 2. The machine 2 may include an opening 2h at the external surface 21 of the machine 2. For example, the opening 2h may recess into the machine 2 from the external surface 21.

The detection module 1 may be attached to and detached from the opening 2h of the machine 2 through the fastening component 13f. For example, the detection module 1 may be mechanically joined or connected to the opening 2h through the fastening component 13f. For example, the detection module 1 may be configured to be securely installed in opening 2h, which constructively forms a part of machine 2.

For example, the fastening component 13f and the opening 2h may have a mechanical or magnetic means to resist or arrest the movement of the detection module 1. The mechanical or magnetic means may prevent unintended separation of the detection module 1 and the opening 2h. The mechanical or magnetic means may include a pin, a post, a spring, a plugger, a buffer, a snap, a clip, a contour, etc.

The machine 2 may have a terminal 2t, which may be configured to electrically connect to a power source or a battery. The terminal 2t may be at least partially exposed. The terminal 2t may be in the opening 2h. After the detection module 1 is attached to the machine 2, terminals 13t1 and 13t2 of the detection module 1 may align with and contact the terminal 2t. The detection module 1 may be electrically connected to a power source or a battery through the terminal 2t. For example, the terminal 2t may provide, constitute, or establish a power supply path between machine 2 and detection module 1. The machine 2 may be configured to supply power to the detection module 1 while the detection module 1 remains attached to the machine 2; therefore, the detection module 1 does not need to be charged separately or externally from machine 2. As a result, users can enjoy uninterrupted operation and convenience, as the detection module 1 can continuously receive power from machine 2 during its use.

Referring back to FIG. 1, the distance detection unit 10 may include a distance detection sensor, which may be configured to measure the distance to an object, determine its location, and/or assess its moving speed. In some arrangements, the distance detection unit 10 may utilize sound waves, such as ultrasonic waves, to perform these functions. In some arrangements, the operating frequency (or working frequency) of the distance detection unit 10 may be in the range of 10 kHz and 30 kHz. Alternatively, the distance detection unit 10 may employ electromagnetic waves, including radio waves, visible light, microwaves, infrared radiation, and ultraviolet light, or other feasible spectra of wavelengths and frequencies.

The distance detection unit 10 may include a carrier 10c, an emitter 10e, a receiver 10r, a package body 10p, terminals 10t1, 10t2, and connection elements 10w1, 10w2.

The carrier 10c may include a substrate. In some arrangements, the carrier 10c may include, for example, a printed circuit board (PCB), such as a paper-based copper foil laminate, a composite copper foil laminate, or a polymer-impregnated glass-fiber-based copper foil laminate.

The carrier 10c may include an interconnection structure or a circuit structure. The circuit structure may include a redistribution layer (RDL), a circuit layer, a conductive pillar, conductive pad, conductive trace, a conductive via, a conductive wire, or other conductive elements. The circuit structure may provide electrical connections for the components connected with the carrier 10c.

The carrier 10c may include a surface 10c1 and a surface 10c2 opposite to the surface 10c1. The carrier 10c may include one or more conductive pads in proximity to, adjacent to, or embedded in and exposed by the surface 10c1 and/or the surface 10c2. The carrier 10c may include a solder resist on the surface 10c1 and/or the surface 10c2 to fully expose or expose at least a portion of the conductive pads for electrical connections.

The surface 10c1 of the carrier 10c may face away from the dielectric material 12. The surface 10c2 of the carrier 10c may face the dielectric material 12. The surface 10c2 of the carrier 10c may be spaced apart from the dielectric material 12 and a portion of the housing 13 by the package body 10p.

The emitter 10e may be disposed over the surface 10c2 of the carrier 10c. The emitter 10e may be disposed between the carrier 10c and a portion of the housing 13. The emitter 10e may be electrically connected to one or more other electrical components (if any) and to the carrier 10c, and the electrical connections may be attained by way of solder bonding, Cu-to-Cu bonding, wire bonding, or hybrid bonding. In some arrangements, the emitter 10e may include a surface 10e1 facing the carrier 10c and a surface 10e2 opposite to the surface 10e1. The surface 10e2 may be an active surface, a front surface, or a front side. The surface 10e1 may be a backside surface or a backside. The surface 10e2 may contact a portion of the housing 13.

In some arrangements, the emitter 10e may include a transducer. For example, the emitter 10e may include a speaker that can convert electrical energy into mechanical energy (such as sound waves). In some arrangements, the emitter 10e may include an ultrasonic-wave emitter or a device that generates ultrasonic waves, which are sound waves with frequencies above the audible range for humans, typically above 20kHz. In some arrangements, the emitter 10e may include a light emitting diode (LED), a laser diode (such as a vertical cavity surface-emitting laser (VCSEL)), a lamp, a laser, any other suitable light source, or a combination thereof.

The receiver 10r may be disposed over the surface 10c2 of the carrier 10c. The receiver 10r may be disposed between the carrier 10c and a portion of the housing 13. The receiver 10r may be disposed adjacent to the emitter 10e. The receiver 10r may be electrically connected to one or more other electrical components (if any) and to the carrier 10c, and the electrical connections may be attained by way of solder bonding, Cu-to-Cu bonding, wire bonding, or hybrid bonding. In some arrangements, the receiver 10r may include a surface 10r1 facing the carrier 10c and a surface 10r2 opposite to the surface 10r1. The surface 10r2 may be an active surface, a front surface, or a front side. The surface 10r1 may be a backside surface or a backside. The surface 10r2 may contact a portion of the housing 13.

In some arrangements, the receiver 10r may include a transducer. For example, the receiver 10r may include a microphone that can convert mechanical energy (such as sound waves) into electrical energy. In some arrangements, the receiver 10r may include an ultrasonic-wave receiver. In some arrangements, the receiver 10r may include a photodetector, a photo-sensor, a photodiode (PD), a charge-coupled device (CCD), a photomultiplier tube, a camera, a spectrometer, or another light-sensitive electronic device.

The emitter 10e may emit sound waves or electromagnetic waves from the surface 10e2 toward the dielectric material 12. The dielectric material 12 may include or define an opening 12o1 over the emitter 10e and an opening 12o2 over the receiver 10r. For example, the opening 12o1 may expose a portion of the emitter 10e, and the opening 12o2 may expose a portion of the receiver 10r, allowing the emitted waves to pass through unobstructed.

In some arrangements, the openings 12o1 and/or 12o2 may be empty. In other arrangements, a transparent material (such as transparent silicone, transparent polyimide, glass, etc.) may be disposed in openings 12o1 and/or 12o2. In some arrangements, the openings 12o1 and 12o2 may have different shapes in a cross-sectional view. For example, the opening 12o1 may taper away from the emitter 10e and the opening 12o2 may taper toward the receiver 10r. For example, the opening 12o1 may gradually narrow as it moves away from the emitter 10e. For example, the opening 12o2 may gradually narrow as it approaches the receiver 10r.

The portion of the housing 13 between the emitter 10e and the dielectric material 12 may have a pattern substantially aligned with the opening 12o1. Similarly, the portion of the housing 13 between the receiver 10r and the dielectric material 12 may have a pattern substantially aligned with the opening 12o2.

The sound waves or electromagnetic waves from the emitter 10e may transmit through the opening 12o1 in the dielectric material 12, be reflected back by an object, transmit through the opening 12o2 in the dielectric material 12, and then be detected by the receiver 10r. The receiver 10r may convert the sound waves or electromagnetic waves into electrical signals.

The package body 10p may be disposed over the carrier 10c. The package body 10p may be disposed between the dielectric material 12 and the carrier 10c. The package body 10p may cover, surround, or encapsulate the emitter 10e and/or the receiver 10r. The package body 10p may have a surface contacting a portion of the housing 13. The package body 10p may have a surface substantially coplanar with the surface 10e2 and/or the surface 10r2. The package body 10p may include, for example, but is not limited to, an epoxy resin having fillers, a molding compound (e.g., an epoxy molding compound or other molding compound), a phenolic compound or material, a material with a silicone dispersed therein, any combination of two or more thereof, or the like.

The terminal 10t1 may be disposed over the surface 10c1 of the carrier 10c and electrically connected with the carrier 10c. The terminal 10t1 may be electrically connected with the terminal 13t1 through the connection element 10w1. In some arrangements, the terminal 13t1 may be configured to electrically connect to a power source or a battery (for example, through the terminal 2t in FIG. 2B). Power may be supplied to the emitter 10e and/or the receiver 10r through the terminal 13t1, the connection element 10w1, the terminal 10t1, and the conductive structures of the carrier 10c.

The terminal 10t2 may be disposed over the surface 10c1 of the carrier 10c and electrically connected with the carrier 10c. The terminal 10t2 may be disposed closer to the communication unit 11 than the terminal 10t1. The terminal 10t2 may be electrically connected with a terminal 11t2 through the connection element 10w2.

In some arrangements, the electrical signals from the receiver 10r may be transmitted to the communication unit 11 through the terminal 10t2, the connection element 10w2, and the terminal 11t2. In some arrangements, the electrical signals from the receiver 10r may be transmitted or radiated by an antenna 11a of the communication unit 11. For example, the connection element 10w2 may provide, constitute, or establish a signal transmission path between the distance detection unit 10 and the communication unit 11.

The communication unit 11 may be configured to convert electrical energy into electromagnetic waves, or vice versa. The communication unit 11 may be configured to transmit and/or receive information over distances. In some arrangements, the communication unit 11 may include a transmitter, a receiver, or a transceiver. In some arrangements, the communication unit 11 may utilize Wi-Fi, Bluetooth, radio frequency (RF) signals, cellular networks, radio broadcasting, or other wireless communication technologies to perform these functions.

The communication unit 11 may include a carrier 11c, an electronic component 11e, a package body 11p, an antenna 11a, terminals 11t1, 11t2, and a connection element 11w1.

The carrier 11c may include a substrate. In some arrangements, the carrier 11c may include, for example, a PCB, such as a paper-based copper foil laminate, a composite copper foil laminate, or a polymer-impregnated glass-fiber-based copper foil laminate.

The carrier 11c may include an interconnection structure or a circuit structure. The circuit structure may include an RDL, a circuit layer, a conductive pillar, conductive pad, conductive trace, a conductive via, a conductive wire, or other conductive elements. The circuit structure may provide electrical connections for the components connected with the carrier 11c.

The carrier 11c may include a surface 11c1 and a surface 11c2 opposite to the surface 11c1. The carrier 11c may include one or more conductive pads in proximity to, adjacent to, or embedded in and exposed by the surface 11c1 and/or the surface 11c2. The carrier 11c may include a solder resist on the surface 11c1 and/or the surface 11c2 to fully expose or expose at least a portion of the conductive pads for electrical connections. The surface 11c1 of the carrier 11c may face away from the dielectric material 12. The surface 11c2 of the carrier 11c may face the dielectric material 12.

The electronic component 11e may be disposed over the surface 11c1 of the carrier 11c. The electronic component 11e may be electrically connected to one or more other electrical components (if any) and to the carrier 11c, and the electrical connections may be attained by way of solder bonding, Cu-to-Cu bonding, wire bonding, or hybrid bonding.

The electronic component 11e may include an integrated circuit (IC), a chip, or a die that includes a semiconductor substrate, one or more integrated circuit devices and one or more overlying interconnection structures therein. In some arrangements, the electronic component 11e may include a controller, a processor, a central processing unit (CPU), a field-programmable gate array (FPGA), an application specific integrated circuit (ASIC), etc. In some arrangements, the electronic component 11e may include a radio frequency IC (RFIC), an analog-to-digital (A/D) converter, a digital-to-analog (D/A) converter, a filter, a low noise amplifier (LNA), a power amplifier, a multiplexer, a demultiplexer, a modulator, and/or a demodulator, etc. In some arrangements, there may be any number of electronic components depending on design requirements.

The electronic component 11e may be electrically connected to the antenna 11a through the carrier 11c. In some arrangements, the electronic component 11 may be configured to generate electromagnetic waves for transmission via the antenna 11a and/or to process received electromagnetic waves from the antenna 11a. In some arrangements, the signal transmission path may be attained by the carrier 10c.

In some arrangements, the electronic component 11e may be configured to control the antenna 11a. For example, the electronic component 11e may be configured to control the impedance matching, the transmitting start and end time, the receiving start and end time, the frequencies (or operating frequencies), the bandwidths (or operating bandwidths), the wavelengths of the electromagnetic waves, etc.

The package body 11p may be disposed over the surface 11c1 of the carrier 11c. The package body 11p may cover, surround, or encapsulate the electronic component 11e. The package body 11p may be spaced apart from the dielectric material 12 by the carrier 11c. The package body 11p may include, for example, but is not limited to, an epoxy resin having fillers, a molding compound (e.g., an epoxy molding compound or other molding compound), a phenolic compound or material, a material with a silicone dispersed therein, any combination of two or more thereof, or the like.

The antenna 11a may be disposed over the surface 11c2 of the carrier 11c. The antenna 11a and the electronic component 11e may be disposed over opposite sides of the carrier 11c. The antenna 11a may be configured to radiate and/or receive electromagnetic waves. For example, the electrical signals transmitted from the receiver 10r and through the terminal 11t2 may be coupled to the antenna 11a, generating electromagnetic waves. In some arrangements, the operating frequency of the communication unit 11 (or the antenna 11a) may be in the range of 10kHz and 30kHz. In some arrangements, the operating frequency of the communication unit 11 may be lower than the operating frequency of the distance detection unit 10. In other words, the operating frequency of the distance detection unit 10 may be higher than the operating frequency of the communication unit 11.

The antenna 11a may include an antenna array or an antenna pattern. For example, the antenna 11a may include a plurality of antennas (or antenna elements). The antenna 11a may be of any suitable type, such as patch antennas, slot-coupled antennas, stacked patches, dipoles, monopoles, etc., and may have different orientations and/or polarizations.

The antenna 11a may be at least partially disposed in the dielectric material 12. The antenna 11a may be at least partially embedded, covered, surrounded, or encapsulated by the dielectric material 12. For example, the antenna 11a may be disposed over the surface 11c2 of the carrier 11c, penetrate the housing 13, and extend into the dielectric material 12. The dielectric material 12 may be disposed over the housing 13. For example, the distance detection unit 10 and the communication unit 11 may be supported by a bottom side of the housing 13, and the dielectric material 12 may be disposed over the bottom side of the housing 13. When the detection module 1 is attached to a machine, the dielectric material 12 may become or constitute a part of an external surface of the machine. The dielectric material 12 may be integrated with a dielectric material of a machine.

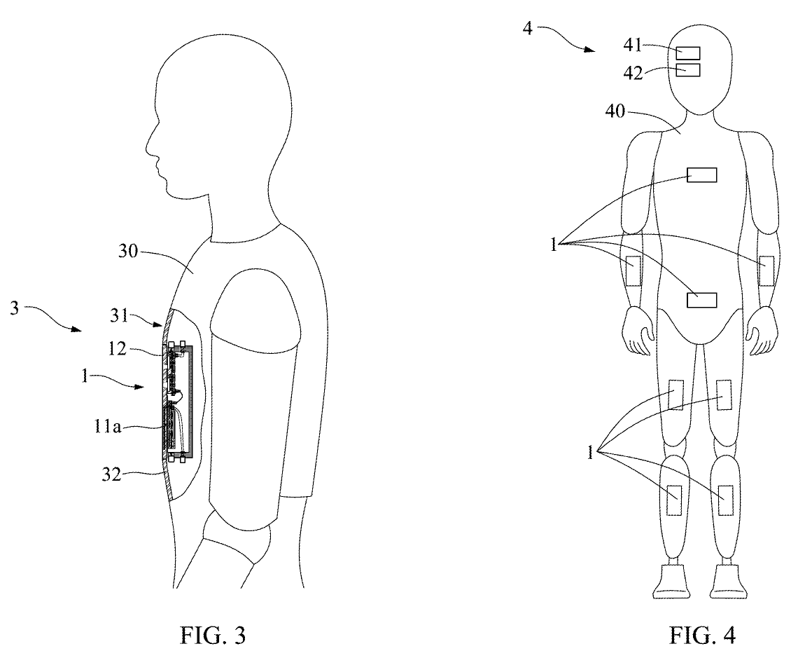

For example, FIG. 3 illustrates an enlarged view of a machine 3 featuring the detection module 1 in accordance with some arrangements of the present disclosure. The machine 3 is similar to the machine 2 in FIG. 2B except that the machine 3 is specifically illustrated as a portion of a humanoid robot.

The machine 3 may have a main body 30, which may include a head, a limb, and a torso. The machine 3 may have an external surface 31 and the detection module 1 may be attached to an opening of the machine 3 from the external surface 31. The machine 3 may have a dielectric material 32 that constitutes the external surface 31. In some embodiments, the dielectric material 32 may be the skin or the outer covering that gives the machine 3 a more human-like appearance and texture.

When the detection module 1 is attached to the machine 3, the dielectric material 12 of the detection module 1 and the dielectric material 32 of the machine 3 may be substantially aligned. For example, the dielectric material 12 of the detection module 1 and the dielectric material 32 of the machine 3 may be substantially or nearly seamless. The dielectric material 12 and the antenna 11a in the dielectric material 12 may be a part of the dielectric material 32 of the machine 3. For example, the antenna 11a of the communication unit 11 may be integrated into the dielectric material 32 of the machine 3. For example, the antenna 11a of the communication unit 11 may be incorporated into the dielectric material 32 of the machine 3.

According to some arrangements of the present disclosure, integrating the antenna 11a into the dielectric material 32 of the machine 3 can eliminate the need for a separate antenna substrate, minimizing the gap and potential interference caused by a separate substrate. Overall, this integration can enhance the radiation efficiency of the antenna 11a and improve signal quality.

In some embodiments, the dielectric material 12 and the dielectric material 32 may have the same material. In some embodiments, the dielectric material 12 and the dielectric material 32 may each include one or more dielectric layers. In some embodiments, the dielectric material 12 and the dielectric material 32 may include a liquid silicone rubber (LSR). In some arrangements, the dielectric material 12 and the dielectric material 32 may include rubber, silicon, sponge, or other suitable materials such as a soft material, an elastic material, or a flexible material. In some embodiments, the dielectric material 12 and the dielectric material 32 may be configured to be adjustable. In some embodiments, the dielectric material 12 may provide additional protection for the antenna 11a.

Referring back to FIG. 1, the terminal 11t1 may be disposed over the surface 11c1 of the carrier 11c and electrically connected with the carrier 11c. The terminal 11t1 may be electrically connected with the terminal 13t2 through the connection element 11w1. In some arrangements, the terminal 13t2 may be configured to electrically connect to a power source or a battery (for example, through the terminal 2t in FIG. 2B). Power may be supplied to the electronic component 11e through the terminal 13t2, the connection element 11w1, the terminal 11t1, and the conductive structures of the carrier 11c.

The connection element 11w1 may extend over the package body 11p. The connection element 11w1 may cross over the package body 11p. However, in some other arrangements, the terminal 11t1 may be closer to the terminal 13t2 than the package body 11p. For example, the terminal 11t1 and the terminal 11t2 may be disposed on opposite sides of the package body 11p.

The connection elements 10w1, 10w2, and 11w1 may include conductive wires. However, in some arrangements, the connection elements 10w1, 10w2, and 11w1 may include conductors of other shapes or configurations, such as wire bundles, cables, pillars, rods, rails, pipes, etc. In some arrangements, the connection elements 10w1, 10w2, and 11w1 may include conductive material such as metal or a metal alloy. Examples of the conductive material include gold (Au), silver (Ag), aluminum (Al), copper (Cu), platinum (Pt), Palladium (Pd), other metal(s) or alloy(s), or a combination of two or more thereof.

The terminal 11t2 may be disposed over the surface 11c1 of the carrier 11c and electrically connected with the carrier 11c. The terminal 11t2 may be disposed closer to the distance detection unit 10 than the terminal 11t1. The terminal 11t1 may be disposed between the terminal 11t2 and the package body 11p.

The detection module 1 may be attached to any designated area of a machine according to the user's requirements. For example, FIG. 4 illustrates a machine 4 equipped with the detection module 1 in accordance with some arrangements of the present disclosure. The machine 4 is similar to the machine 3 in FIG. 3 except that the machine 4 has multiple designated openings for mounting the detection modules 1.

The machine 4 may have a main body 40, which may include a head, a limb, and a torso. The detection modules 1 may be connected to the limbs and torso of the humanoid robot. The positions, functions, and number of detection modules 1 in the machine 4 are not intended to limit the present disclosure. For example, there may be any number of detection modules 1 in the machine 4 depending on design requirements.

In some arrangements, the machine 4 may have an electronic component 41 and a detection module 42. The electronic component 41 and the detection module 42 may be connected to the head of the humanoid robot.

The detection module 42 may be similar to the detection module 1 of FIG. 1. The detection module 42 and the detection module 1 may be configured to detect the external environment using different methods or principles. For example, the detection module 42 may employ electromagnetic waves, including radio waves, visible light, microwaves, infrared radiation, and ultraviolet light, or other feasible spectra of wavelengths and frequencies. For example, the detection module 1 may utilize sound waves, such as ultrasonic waves. For example, detection module 42 may include an optical sensor, while detection module 1 may include an ultrasonic sensor, or vice versa.

The detection module 42 and the detection module 1 may be configured to receive or function with different information from the external environment. For example, the detection module 42 may receive or function with electromagnetic waves and the detection module 1 may receive or function with sound waves.

The detection module 42 and the detection module 1 may be configured to detect the external environment from different locations on the machine 4. For example, the detection module 42 and the detection module 1 may be disposed at distinct physical locations on the machine 4.

The detection module 42 and the detection module 1 may be configured to detect different external areas with respect to the machine 4. For example, the detection module 42 and the detection module 1 may be configured to receive or function with information from different external areas. For example, the detection module 42 and the detection module 1 may be configured to receive or function with information from different distances with respect to the machine 4. For example, the detection module 42 and the detection module 1 may be configured to receive or function with information from different orientations with respect to the machine 4. For example, the detection module 42 and the detection module 1 may have different detection distances. For example, the detection module 42 and the detection module 1 may have different detection orientations. For example, the detection module 42 and the detection module 1 may orient in different directions.

For example, the detection module 42 and the detection module 1 may enhance the overall situational awareness of the machine 4. By utilizing multiple detection points, the machine 4 can gather comprehensive data about environmental conditions, obstacles, and other relevant factors, thereby improving the ability to respond effectively to its surroundings.

The electronic component 41 may include an IC, a chip, or a die that includes a semiconductor substrate, one or more integrated circuit devices and one or more overlying interconnection structures therein. For example, the electronic component 41 may include a controller, a processor, a CPU, a FPGA, an ASIC, etc. The electronic component 41 may include a single chip or a plurality of chips.

In some arrangements, the electronic component 41 may be configured to wirelessly communicate with the detection module 1 and the detection module 42. In some arrangements, the electronic component 41 may be configured to control the movement of the machine 4 based on the electromagnetic waves radiated from the detection module 1.

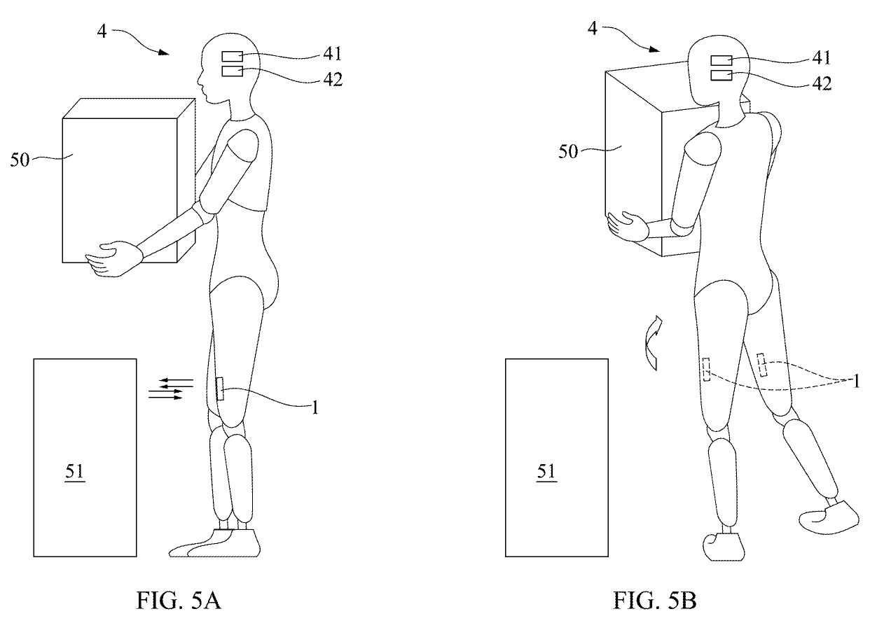

For example, FIGS. 5A and 5B illustrate one or more steps in a process flow that demonstrate how the machine 4 avoids collisions by using the detection module 1 in accordance with some arrangements of the present disclosure. When the machine 4 is transporting object 50, the presence of object 50 obstructs the sensing path of detection module 42, preventing it from detecting object 51. The detection module 1 may detect the object 51, generate a signal accordingly, and transmit the signal to the electronic component 41 wirelessly. In some arrangements, the detection module 1 may be disposed in a blind spot of detection module 42 to enhance the overall detection capability of the machine by ensuring that areas missed by the module 42 are still monitored. For example, the detection module 1 may be disposed in an area that the detection module 42 cannot effectively monitor or detect.

The electronic component 41 may process the signal and determine whether and/or how to move the machine 4 to avoid collision. For example, the electronic component 41 may control the machine 4 to turn around to avoid collision with the object 51. For example, the electronic component 41 may measure the time it takes for the sound waves or electromagnetic waves to bounce back after hitting the object 51. In some arrangements, the time delay between sending and receiving the sound waves is used to calculate the distance between the machine 4 and the object 51. In some arrangements, the time required for the light to return can be measured, or the intensity of the reflected light can be analyzed to determine the distance between the machine 4 and the object 51.

According to some arrangements of the present disclosure, the detection module 1, which integrates distance detection and communication functions, can be easily attached to and detached from any designated location on a machine, such as the machines 2, 3, and 4. This achieves comprehensive environmental sensing and addresses potential blind spots or obstructions. The modular design offers users greater installation flexibility and facilitates maintenance. Additionally, the detection module 1 can communicate wirelessly, and the antenna 11a can be integrated within the machine, further optimizing space and simplifying the circuits inside the machine.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5µm, no greater than 2µm, no greater than 1µm, or no greater than 0.5µm. A surface can be deemed to be substantially flat if a displacement between a highest point and a lowest point of the surface is no greater than 5µm, no greater than 2µm, no greater than 1µm, or no greater than 0.5µm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A machine, comprising:
a main body;
a first detection module connected to the main body;
a second detection module connected to the main body, wherein a detection distance of the first detection module and a detection distance of the second detection module are different; and
an electronic component wirelessly communicating with the first detection module and the second detection module, wherein the electronic component is configured to control a movement of the main body.

2. The machine of claim 1, wherein the first detection module and the second detection module are configured to detect different external areas with respect to the machine.

3. The machine of claim 1, wherein the first detection module includes an optical sensor and the second detection module includes an ultrasonic sensor.

4. The machine of claim 3, wherein the second detection module includes a distance detection unit and a communication unit, and an operating frequency of the distance detection unit is higher than an operating frequency of the communication unit.

5. The machine of claim 1, wherein the second detection module has a dielectric layer, and the dielectric layer of the second detection module constitutes a part of an external surface of the machine.

6. The machine of claim 5, wherein the second detection module includes a distance detection unit and a communication unit, and the dielectric layer defines two openings over the distance detection unit.

7. The machine of claim 6, wherein the two openings includes a first opening over an emitter of the distance detection unit and a second opening over a receiver of the distance detection unit.

8. The machine of claim 1, wherein the second detection module includes a distance detection unit and a communication unit.

9. The machine of claim 8, wherein the communication unit is configured to wirelessly communicate with the electronic component.

10. The machine of claim 9, wherein the first detection module and the distance detection unit are configured to receive information from different orientations with respect to the machine.

11. A detection module, comprising:
a distance detection unit; and
a communication unit wirelessly communicating with a processing unit, wherein the communication unit includes an antenna in a soft material.

12. The detection module of claim 11, wherein the distance detection unit includes an ultrasonic sensor, and an operating frequency of the distance detection unit is higher than an operating frequency of the communication unit.

13. The detection module of claim 11, wherein the communication unit includes a carrier, and the antenna is disposed over the carrier and extends into the soft material.

14. The detection module of claim 11, further comprising:
a connection element electrically connecting between the distance detection unit and the communication unit.

15. The detection module of claim 11, further comprising:
a fastening component that allows the detection module to be attached to a machine, wherein when the detection module is attached to the machine, the soft material of the detection module constitutes a part of a soft material of the machine.

16. The detection module of claim 15, wherein when the detection module is attached to the machine, the soft material of the detection module is substantially aligned with the soft material of the machine.

17. A detection module, comprising:
a distance detection unit;
a communication unit wirelessly communicating with a processing unit; and
a fastening component that allows the detection module to be attached to and detached from a designated area of an external surface of a machine.

18. The detection module of claim 17, further comprising:
a housing defining a space for accommodating the distance detection unit and the communication unit, and housing comprises the fastening component.

19. The detection module of claim 18, wherein the housing includes a terminal configured to be electrically connected to a power source when the detection module is attached to the designated area.

20. The detection module of claim 18, further comprising:
a soft material disposed over the housing, wherein when the detection module is attached to the machine, the soft material of the detection module constitutes a part of the external surface of a machine.
